(19) United States
(12) Patent Application Publication
(10) Pub. No.: US 2015/0201086 A1
(43) Pub. Date: Jul. 16, 2015

(54) VoIP BASED TELEPHONY METHOD AND SYSTEM

(71) Applicant: PT Konvergensi Digital Internasional, Jakarta Selatan (ID)

(72) Inventors: Jastiro Abi, Jakarta Selatan (ID); Harya Mitra Hidayat, Jakarta Selatan (ID)

(21) Appl. No.: 14/317,075

(22) Filed: Jun. 27, 2014

(30) Foreign Application Priority Data
Jan. 14, 2014 (ID) P00201400448

(51) Int. Cl. H04M 7/00; H04M 1/725

(52) U.S. Cl. CPC H04M 7/006; H04M 1/72552

(57) ABSTRACT

A virtual phone application providing telephone service, for example a virtual phone using a Voice over Internet Protocol (VoIP) network. An internet enabled device (10), configured to implement the virtual phone application, wherein the virtual phone application is assigned with a telephone number, such as a E.164 number, with which the virtual phone application can initiate or receive a telephone call and SMS via VOIP. The Virtual phone of internet enabled device (10) is able to provide a communication system for establishing regular telephony services using a

VoIP network to any phone line such as telephone call and short message service (SMS). Further, the virtual phone application is able to provide a ring back tone to the caller, making an emergency number dialling via VOIP, doing an identification of user location (GPS).

### FIELD OF THE INVENTION

This invention relates generally to a telephony method and a corresponding system, and more particularly to a virtual telephony application, method and system in a Voice over Internet Protocol (VoIP) network.

### BACKGROUND

Numerous advances have been made in recent years in the field of telecommunications. In particular, the field of internet telephony has emerged as a viable technology that is evolving rapidly. A lot of effort has been put on transmitting voice data through Internet. The VoIP (Voice over Internet Protocol) is a popular Internet protocol about the transmission of voice data packets. VoIP has become widespread among Internet users. A VoIP call typically involves a signaling session and a media session. The signaling can be accomplished using various protocols such as Session Initiation Protocol (SIP), H.323 Protocol, or any other suitable signaling protocols. SIP is an application-layer control (signaling) protocol that is used for creating, modifying, and terminating sessions with one or more participants. These sessions can include Internet telephone calls, multimedia distribution, and multimedia conferences. SIP clients use Transmission Control Protocol (TCP) or User Datagram Protocol (UDP) to connect to SIP servers and other SIP endpoints. H.323 defines the protocols that provide audio-visual communication sessions on any packet network; and is commonly used in VoIP and IP-based video conferencing.

A VoIP or Internet-based telephone services, or IP telephony, presently offer significant benefits over traditional telephone service. Although users generally pay a fee for internet access, it is usually a set amount on a monthly basis regardless of the amount of bandwidth used. If two people use the internet to call one another, they can by-pass both local telephone companies networks and the long distance carrier's network, without incurring additional fees for making such a call. This type of IP telephony, that does not require any intermediary service (charged at some price), needs both users to be using the same software at the same time and to know that the other user is available on-line at the designated time of the call.

Nowadays, it is desirable to extend VoIP to link the regular phone systems for forming a greater communication network. A commercial solution offered by Skype implements a peer-to-peer internet telephony software application. The software application enables peer-to-peer or computer-to-computer VoIP calls. The Skype™ service also offers a hosted, fee-based service, referred to as SkypeOut™, which allows computer users to initiate calls to non-computer-based landline or cellular telephones from a desktop application. Another hosted, fee-based service, SkypeIn™, allows computer users to receive incoming calls from non-computer-based landline or cellular telephones on their computer.

Also it is desirable to use a telephone number in initiating a call using VoIP network. Internationally, telephone numbers are systematically organized by the E.164 standard, while the Internet uses the Domain Name System (DNS) for linking domain names to IP addresses and other resource information. Telephone number mapping systems provide facilities to determine applicable Internet communications servers responsible for servicing a given telephone number using DNS queries.

The most prominent facility for telephone number mapping is the E.164 Number Mapping (ENUM) standard. It uses special DNS record types to translate a telephone number into a Uniform Resource Identifier (URI) or IP address that can be used in Internet communications.

A need continues to exist for improving internet and VoIP based telephony methods and systems.

### SUMMARY OF THE INVENTION

The embodiments of the present invention provide a virtual phone application capable of providing regular telephony services such as initiating or receiving a telephone call or a SMS with a telephone number (such as a telephone number according to the E.164 standard), providing a ring back tone during an incoming call, providing an identification of user location (such as the user's GPS coordinates), and making an emergency number dialling via VoIP.

According to a first embodiment of this invention, there is provided an internet enabled device (which may be a telephone or other devices that can communicate with other devices via the internet) configured to implement a virtual phone application, wherein the virtual phone application (or a user account of the application) is assigned with a telephone number according to the E.164 standard, with which the virtual phone application can provide regular telephony services via VoIP. The telephone number may be associated with multiple numbers (such as a home telephone number and a roaming telephone number) based on the location of calling user of the internet-enabled device.

According to a second embodiment of this invention, there is provided a communication system for establishing a regular telephony services via virtual phone application using a VoIP network between an internet enabled telephone device and any phone line, the communication system comprising: a virtual phone application on the device configured to initiate a call request, a VoIP server configured to receive and analyze a dialed number of the call request from the device, a Session Border Controller (SBC) configured to receive the call request from the VoIP server and process transcoding if it is necessary, a gateway switching center configured to receive and analyze the call request from the SBC and route the call request to a respective point of interconnection. The virtual phone application is also capable of receiving an incoming call from any phone line. According to another embodiment of this invention, there is provided a communication system for establishing a short message service (SMS) message via a virtual phone application using a VoIP network between an internet enabled telephone device and any phone line, the communication system comprising: a virtual phone application on the device configured to initiate a SMS request, a web server configured to receive the SMS over (Hyper Text Transfer Protocol) HTTP, a Vector Signal Generator (VSG) configured to receive the SMS over Transmission Control Protocol (TCP) from the web server, a SMS gateway configured to receive the SMS over HTTP, an operator of SMS Center (SMSC) network configured to receive the SMS over Short Message Pear-to-Pear (SMPP) which in turn send the SMS to the recipient. The virtual phone is also capable of receiving an incoming SMS from any phone line.

According to another embodiment of this invention, the virtual phone application is capable of performing an identification of a user location. The device (Mobile Platform) client will fetch updated information (cell-info or GPS coordinates) as soon as the user starts using the virtual phone application and/or other services/applications. The location identification is used for customised caller line presentation.

Based on another embodiment, the telephone number assigned to the virtual phone application of the internet enabled device has a dynamic change of numbering based on a location of the device. The VoIP server, based on the identified location using the method explained above, changes the telephone number of the user. The changed number appears as Caller Line Identity (CLI) in outgoing calls and SMSs. Though the caller line presentation is different from a primary number (home number) allocated to the user, voice and SMS calls can be received in both numbers.

Further, according to another embodiment of this invention, the virtual phone application of the internet enabled device is capable of making an emergency number dialling. A database of locations and numbers for emergency services like fire, police and ambulance service are maintained in the VoIP server.

Another embodiment of the present invention provides an apparatus, configured to receive a call request or a SMS directed to a E.164 number associated with a virtual phone application installed on a internet-enabled device, wherein the apparatus is configured to analyse the E.164 number, and if the E.164 number is within a range of E.164 numbers associated with VoIP services provided by a VoIP server, to forward the call request to the VoIP server, and/or if the E.164 number is within a range of E.164 numbers associated with services provided by an IM server, to forward the SMS to the IM server.

Another embodiment of the present invention provides a server, configured to provide VoIP services to a plurality of internet-enabled devices, wherein each of said plurality of internet-enabled devices has a virtual phone application assigned with its respective E.164 number, wherein the server is configured to analyzes a E.164 number associated with an incoming call or an incoming SMS, and if the E.164 number matches one of the E.164 numbers associated with one of the plurality of the internet-enabled devices, to forward the incoming call or the incoming SMS to said one of the plurality of internet enabled devices.

Another embodiment of the present invention provides a virtual phone application program, when run on an internet enabled device, performing the method of initiating or receiving a telephone call or a SMS via VoIP, wherein the virtual phone application is assigned with a telephone number according to the E.164 standard.

Another embodiment of present invention is that the caller is provided with a customised ringtone set by the called party. In current telephony networks, it is termed as Colour Ring Back Tone (CRBT) but the features are so far not available on VOIP services. In addition, the invention provides ring back tone which indicates a state of the call.

### BRIEF EXPLANATION OF DRAWINGS

FIG. 1 illustrates a system for processing an outgoing call from an internet-enabled device to a regular telephony device according to a first embodiment of the present invention.

FIG. 2 illustrates a detail of flow diagram for processing an on net call from an internet-enabled device to a regular telephony device according to a first embodiment of the present invention.

FIG. 3 illustrates a detail of flow diagram for processing an off net call from an internet-enabled device to a regular telephony device according to a first embodiment of the present invention.

FIG. 4 illustrates a system for processing an incoming call from a regular telephony device to an internet enabled device according to the first embodiment of the present invention.

FIG. 5 illustrates a detail of flow diagram for processing an incoming call from a regular telephony device to an internet enabled device according to the first embodiment of the present invention.

FIG. 6 illustrates a system for processing an outgoing SMS from an internet-enabled device to a regular telephony device according to a second embodiment of the present invention.

FIG. 7 illustrates a detail of flow diagram for processing an outgoing SMS from an internet-enabled device to a regular telephony device according to a second embodiment of the present invention.

FIG. 8 illustrates a system for processing an incoming SMS from a regular telephony device to an internet enabled device according to the second embodiment of the present invention.

FIG. 9 illustrates a detail of diagram for processing an incoming SMS from an internet-enabled device to a regular telephony device according to a second embodiment of the present invention.

FIG. 10 illustrates a system for providing a ring back tone during an incoming call according to another embodiment of the present invention.

FIG. 11 illustrates a detail flow diagram of online-success for providing a ring back tone during an incoming call according to another embodiment of the present invention.

FIG. 12 illustrates a detail flow diagram of online-timeout (MVoIP) for providing a ring back tone during an incoming call according to another embodiment of the present invention.

FIG. 13 illustrates a detail flow diagram of online-timeout (GSMC) for providing a ring back tone during an incoming call according to another embodiment of the present invention.

FIG. 14 illustrates a detail flow diagram of online-busy for providing a ring back tone during an incoming call according to another embodiment of the present invention.

FIG. 15 illustrates a detail flow diagram of GCM (Google Cloud Messaging)-Success (MVoIP) for providing a ring back tone during an incoming call according to another embodiment of the present invention.

FIG. 16 illustrates a detail flow diagram of GCM-Success (GSMC) for providing a ring back tone during an incoming call according to another embodiment of the present invention.

FIG. 17 illustrates a detail flow diagram of GCM-timeout for providing a ring back tone during an incoming call according to another embodiment of the present invention.

FIG. 18 illustrates a detail flow diagram of GCM-not register for providing a ring back tone during an incoming call according to another embodiment of the present invention.

FIG. 19 illustrates a detail flow diagram of MvoIP-GMSC/transcoder for providing a ring back tone during an incoming call according to another embodiment of the present invention.

### DETAILED DESCRIPTION

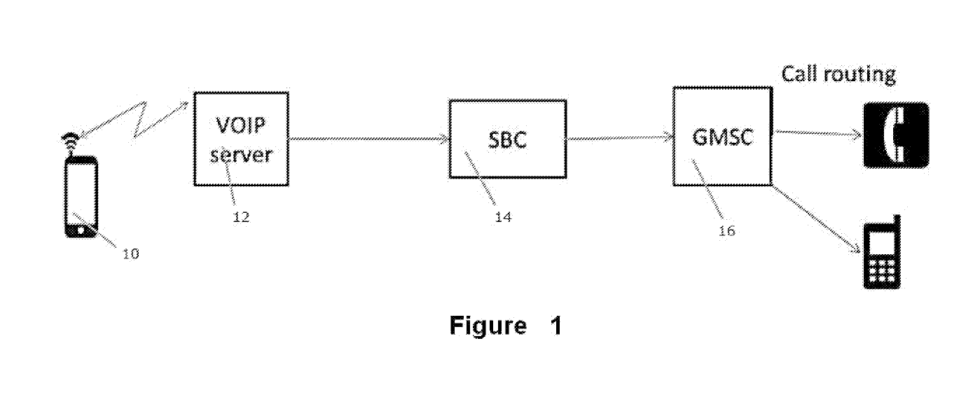

FIG. 1 is a system of an outgoing call from an internet enabled device to a regular telephony device according to the first embodiment of the present invention. An internet enabled device (10), such as a mobile phone connected to the internet, is provided with a virtual phone application, which is a user application installed onto the internet enabled device (10). A telephone number, which may be a phone number according to the E.164 standard, is assigned to the virtual phone application and/or a user's account of the virtual phone application after the application is installed.

The virtual phone application may provide different users with their respective user accounts and/or their respective virtual identities. At least one E.164 number is assigned to each of the users' accounts and/or their virtual identities. When an outgoing call is initiated from the virtual phone application on the device (10), a VoIP server (12) serving the device (10) detects the dialed digits input by a user of the device (10) and then authenticaticates the calling party as well as determining a charging of the call. The VoIP server (12) will work with a database containing a range of E.164 numbers to determine whether or not the dialed number is within the range. If it is within the range, the VoIP server will have direct access to the dialed device and the call will be processed internally within the VoIP network. If it is not, the VoIP server (12) will forward the call under the Session Initiation Protocol (SIP) to a Session border controller (SBC) (14). The calling E.164 number may also be forwarded under the SIP protocol to the SBC (14). The SBC (14) processes the call request and performs transcoding if required in certain scenarios based on the capability of a gateway switching centre (GMSC) (16). The SBC (14) then sends the call request to the operator's GMSC (16). The GMSC (16) then delivers the call to a point of interconnect with other operators over the Public Switched Telephone Networks user parts (ISUP), international carriers, or if the dialed number belongs to the operator's own wireless network, queries the Home Location Register (HLR) for call routing to a respective Mobile switching centre within the HLR.

The above outgoing call has a charging system which charges the user based on the amount of data transmitted and/or received during the conversation instead of the amount of time for which the conversation lasts. For example, a call may have a duration of one-hour but the transmission of data relating to the user's conversation may last for only thirty-minutes. In such a case the call will be charged for the amount of data transmitted during said thirty-minutes only. The volume of speech bytes (data representing a speech) on every call is monitored and counted through a module, such as a parallel sniffing port, which is the port that receives IP packets containing copied/duplicate packets from another port. Speech bytes are identified with specific headers in the IP packets that traverse from the client device to the GMSC (16) through the VoIP platform. A Voice Activity Detection (VAD) algorithm is used to activate the speech path only when a conversation is made. As per an initial experimental observation, every second of speech contains about 2 KB of information in specific CODEC conditions.

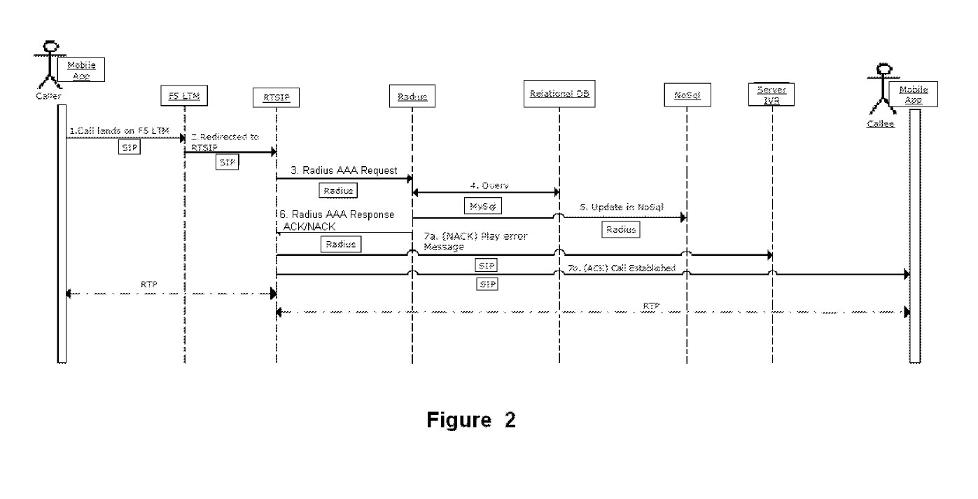

A flow diagram for processing an on net call from an internet-enabled device to a regular telephony device is illustrated in FIG. 2. The flows are as follow: 1. caller dials a destination and lands on F5LTM (F5 Load Traffic Manager) which is a Load balancer device; 2. F5 redirect the call to RTSIP server (SIP Server with RTP Proxy capability); 3. RTSIP requests Radius server for AAA (Authentication, Authorization, Accounting); 4. Radius server sends a query to DB (database) for required information; 5. Radius server updates the NoSql server; 6. radius responds with Ack/Nack (acknowledgment/Negative Acknowledgment); 7a. (NACK) Interactive Voice Response (IVR) server plays error message; 7b. (ACK) Call is established with the Callee.

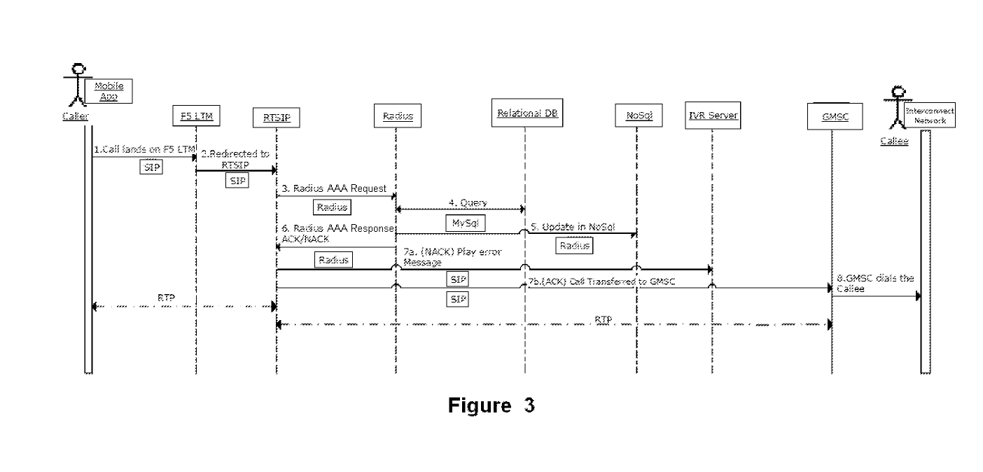

A flow diagram for processing an off net call from an internet-enabled device to a regular telephony device is illustrated in FIG. 3. The flows are as follow: 1. caller dials a destination and lands on F5LTM; 2. F5 redirects the call to RTSIP server; 3. RTSIP requests Radius server for AAA; 4. Radius server sends a query to DB for required information; 5. Radius server updates the NoSql server; 6. radius responds with Ack/Nack; 7a. (NACK) IVR server plays error message; 7b. Call is transferred to GMSC (16); 8. GMSC (16) dials the required destination number.

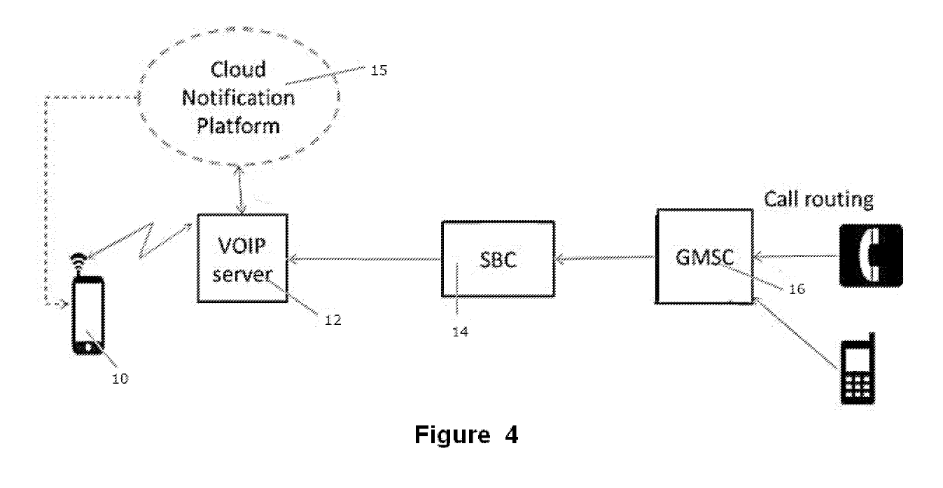

FIG. 4 is a system of an incoming call from an arbitary telephone number to the internet enabled device (10) with the virtual phone application according to the first embodiment of the present invention. When the E.164 number dialed in a call belongs to the GMSC (16) operator's allocated range of numbers, the call, which may be from anywhere in the world, will be routed to the GMSC (16), and the dialled digits of the called E.164 number are analysed by the GMSC (16). If the dialled digits match the VoIP service segment which is a range of typical E.164 numbers assigned for the VoIP Services of the VoIP server (12), the GMSC (16) will route the call to the VoIP server (12) through the SBC (14). The SBC (14) may do SIP signalling modifications and hands over the call to the VoIP server (12). The status of the call, such as hunting, ringing, answering and disconnecting, are managed and translated between the VoIP server (12) and the GMSC (16) through the SBC (14). The VoIP server (12) analyzes the current status of the dialed user. If the dialed user is on line then the call request is placed directly to the dialed user client, which the dialed E.164 number is associated with. If the dialed user is not active or not on line, then a paging notification is sent through cloud servers (15) from an internet server, such as Google, Apple and Blackberry, to “wake up” (or in other words, notify) the client. The client wake up process is followed by location notification to the server. Based on the location of the user client, the call gets delivered.

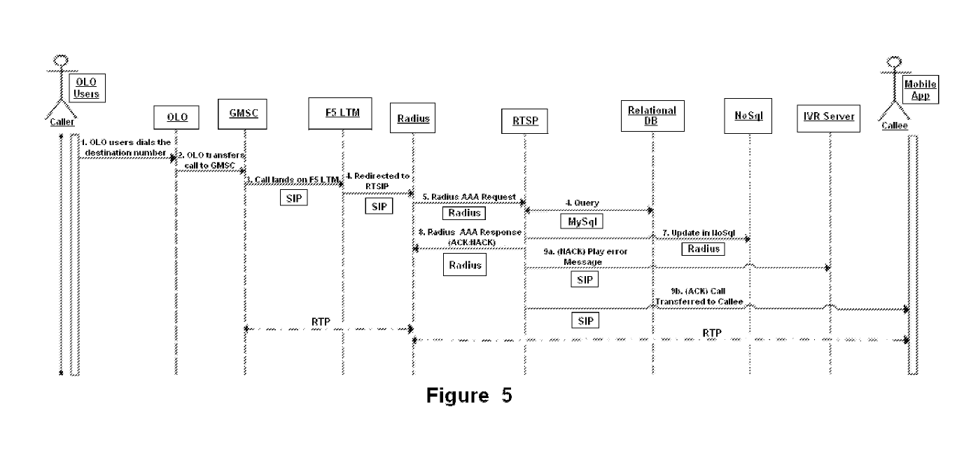

A flow diagram for processing an incoming call from a regular telephony device to an internet-enabled device is illustrated in FIG. 5. The flows are as follow: 1. caller dials a destination and lands on OLO (Other Licenses Operator); 2. OLO transfer the call to GMSC (16); 3. The call lands on F5LTM; 4. F5 redirects the call to RTSIP server; 5. RTSIP requests Radius server for AAA; 6. Radius server sends a query to DB for required information; 7. Radius server updates the NoSql server; 8. radius responds with Ack/Nack; 9a. (NACK) IVR server plays error message; 9b. Call is transferred to GMSC (16); 8. GMSC dials the required destination number.

The incoming call according to the above process is also provided with a color ring back tone (CRBT) and a regular ring back tone (RBT). For CRBT, a caller can hear a ring back tone as a music of the choice of the called party (i.e. VoIP user) during ringing. This service needs to be subscribed by the VoIP user. For RBT, the caller can hear different ring tones based on the status of the call.

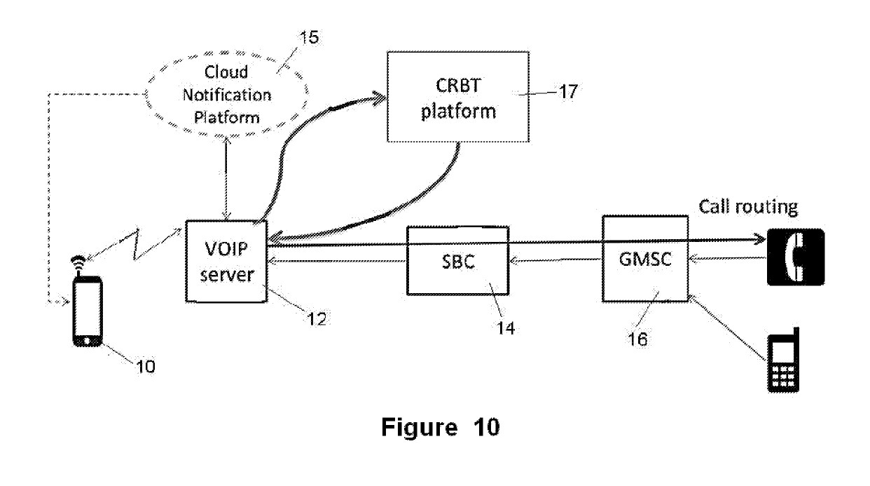

In order to indicate a state of the called party, a status of the called party is preferably provided to the caller. Referring to FIG. 10, according to an embodiment of this invention, the mobile VoIP server (12) associated with the called party's internet-enabled device (10) may provide the status of the called party which indicates e.g. his availablity, how busy he is and whether he has logged in. Further, after the client is succesfully notified, the mobile VoIP server (12) will send the called party's number to a Caller Ring Back Tones (CRBT) platform (17) to play music. The music is then relayed during ringing stage to the caller's device.

In addition, a Ring Back Tone (RBT) is provided in one embodiment of the invention. The ringtones will be different for different status of the call, which include at least one of the following status: when the call reaches the VoIP Server (16); the called party is paged/notified through Google Cloud Messaging (GCM), Apple Push Notification (APN); the application is opened with answer/reject screen; call is rejected; call is not answered and the called party is not reachable. As each status of the call has a different RBT, the RBT therefore indicates the call status to the caller.

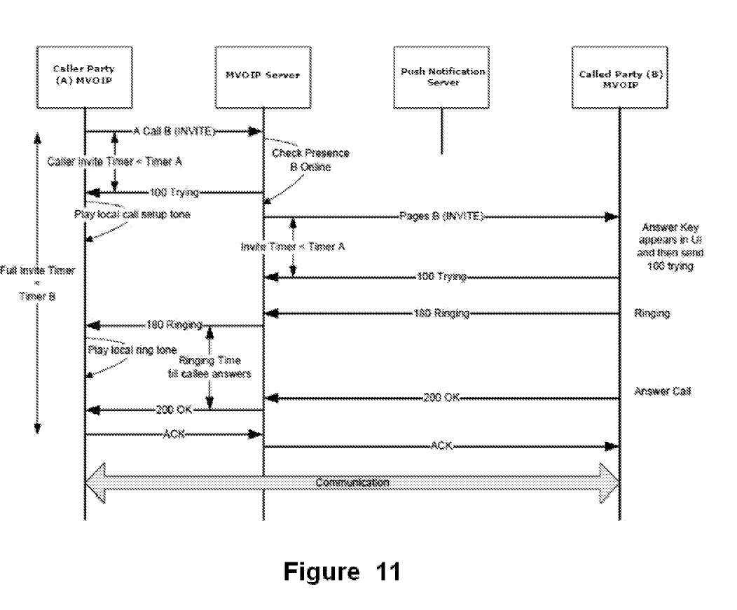

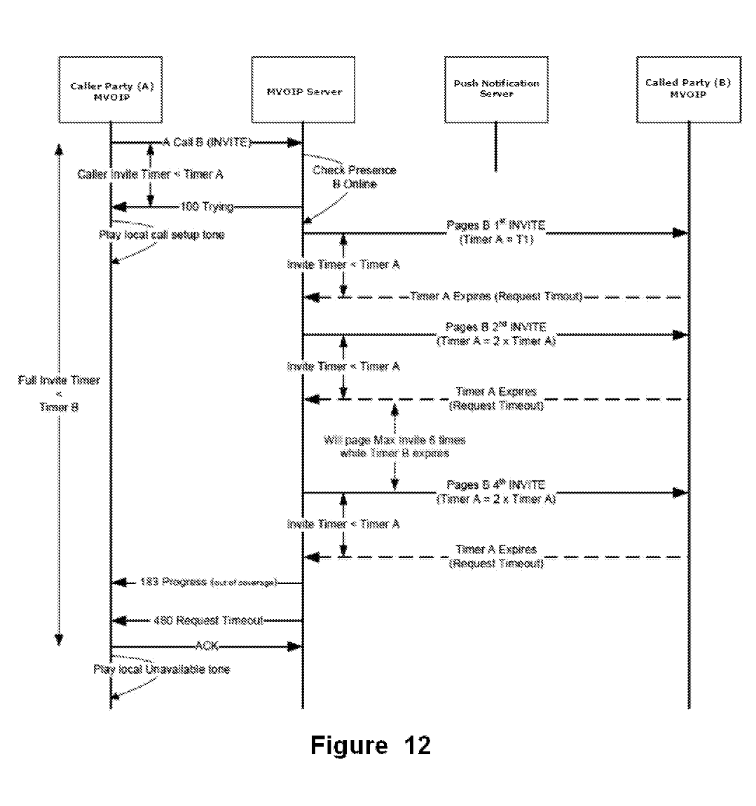

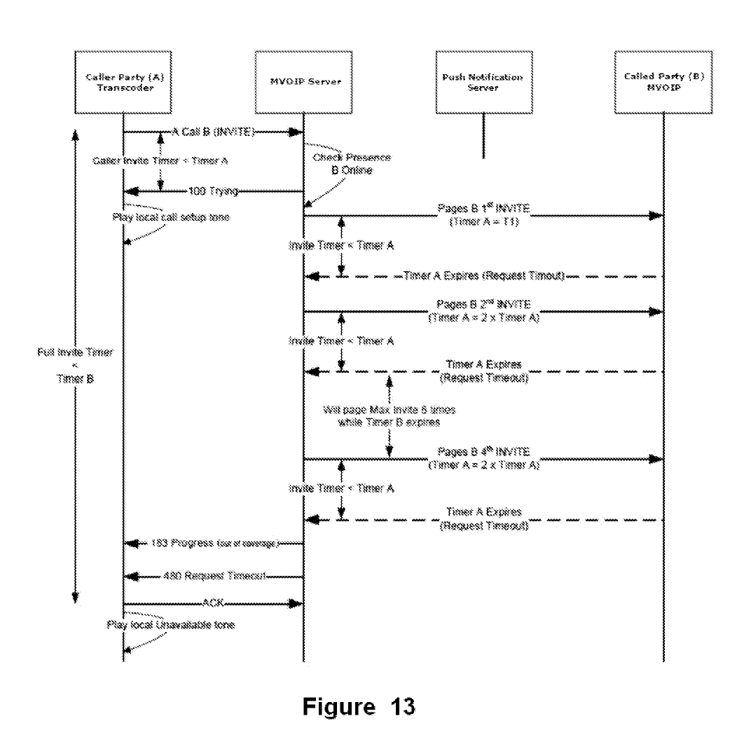

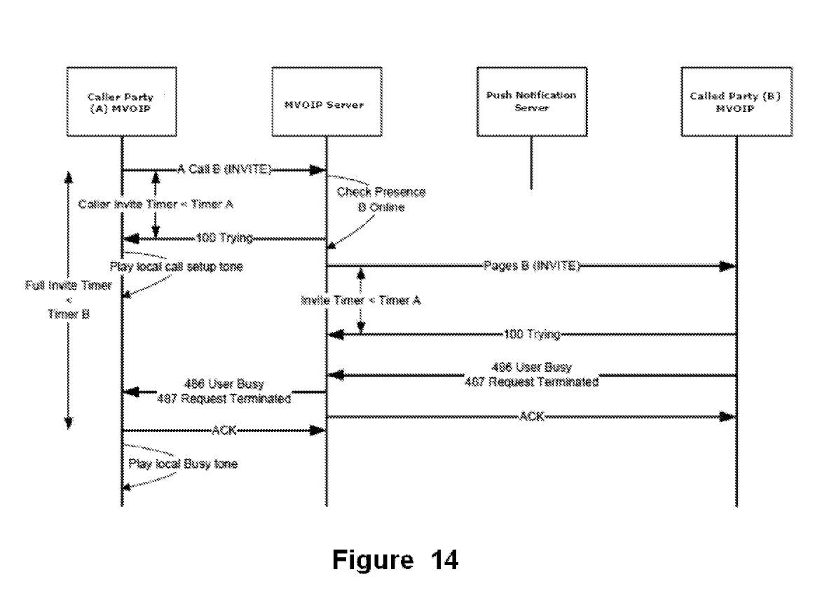

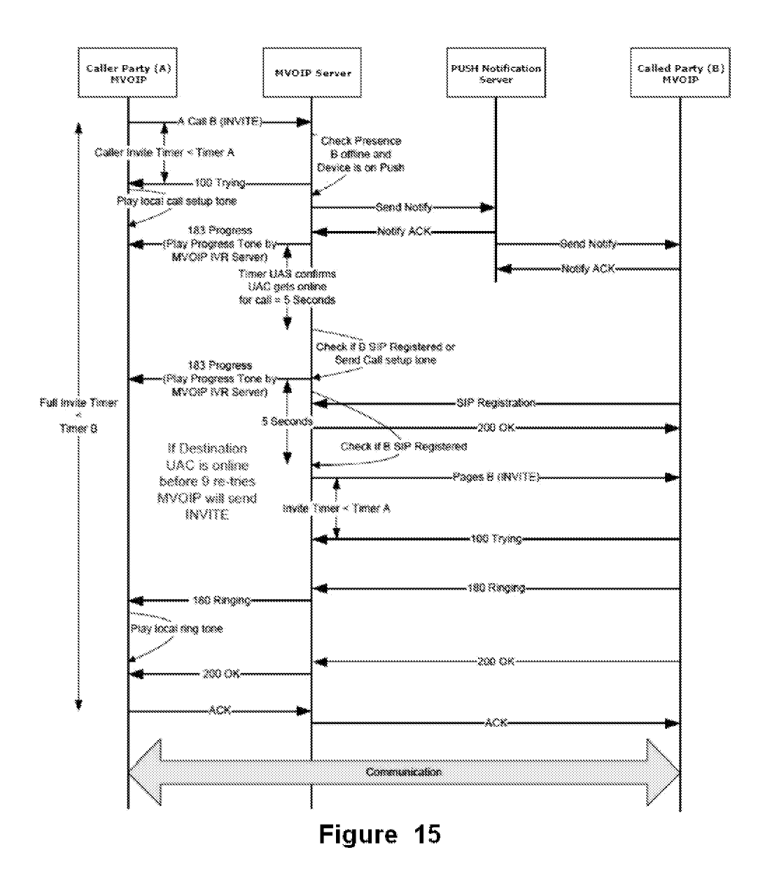

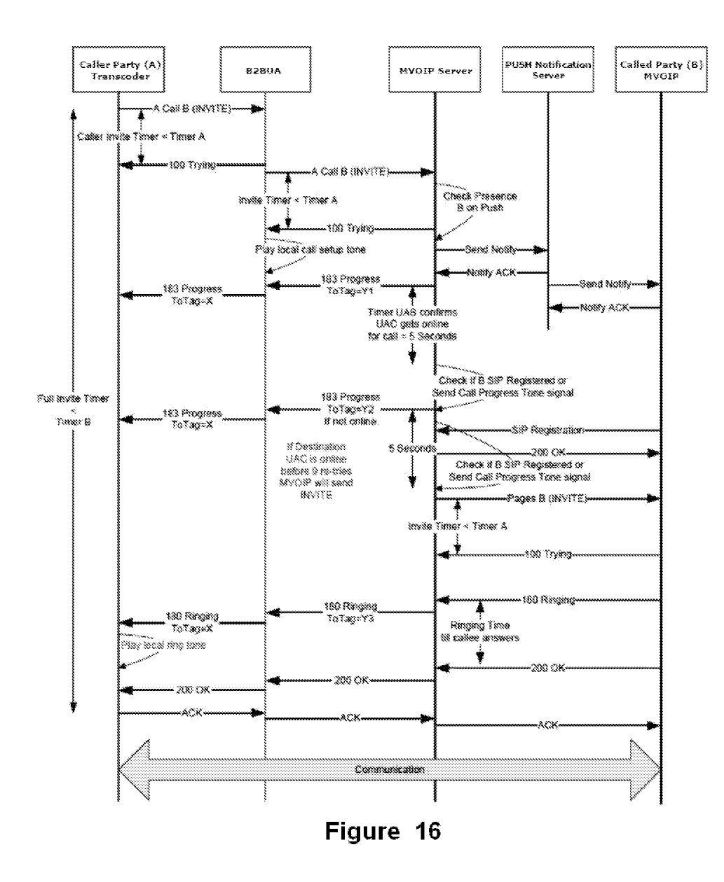

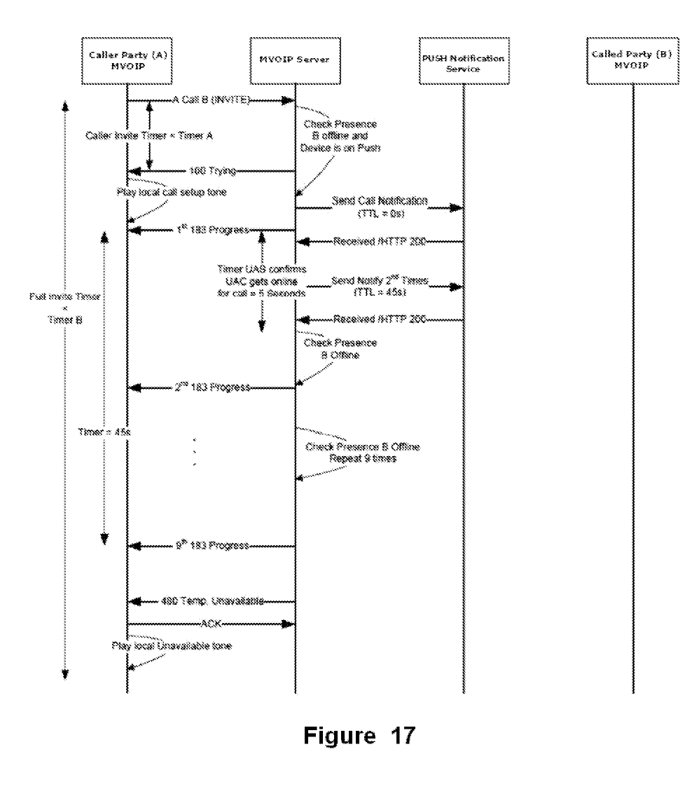

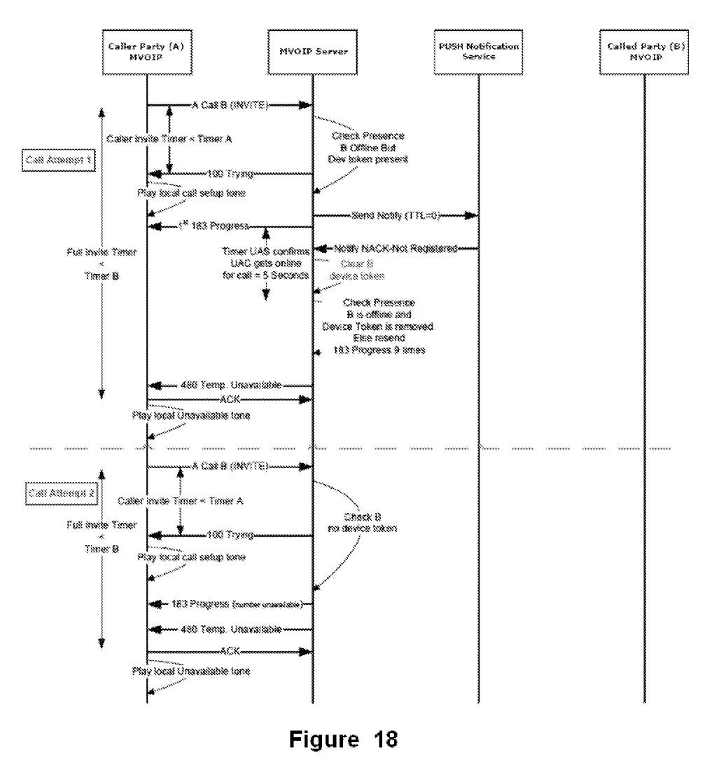

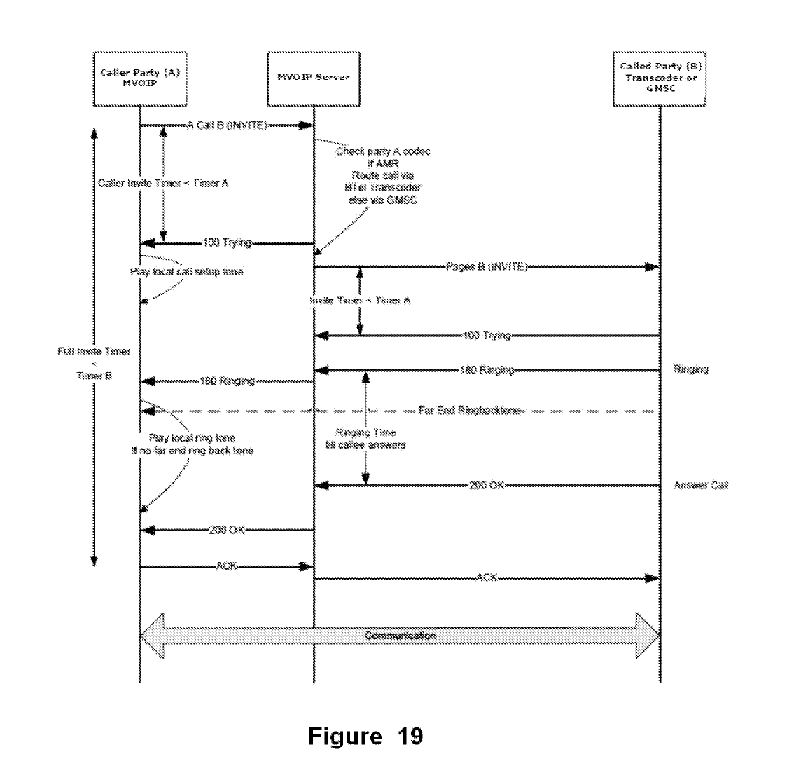

FIGS. 11-19 illustrate a detail flow diagram for providing a ring back tone during an incoming call. The figures show states of scenarios that would occured during incoming call such as online-success; online-timeout (MVoIP); Online-tirneout (GSMC); online-busy; Google Cloud Messaging (GCM)-Success (MvoIP); GCM-success (GMSC); GCM-tirneout; GCM-not register and MvoIP-GMSC/transcoder. Those figures has specific conditions where:

T1=500 ms (default SIP−500 ms);

Timer A=2*Timer A, where initial Timer A=T1;

Timer B=64*T1=32 seconds (default SIP value=32 seconds), it will request timeout after this timer expire;

Invite Timer=if invite timer is greater than Timer A, UAS and UAC resend the invite with 2*TimerA;

Full Invite Timer=if that expires before getting ACK, the invite will be destroyed.

Caller Invite Timer=this is to handle the re-transmission of invite until 100 Trying is received from UAS.

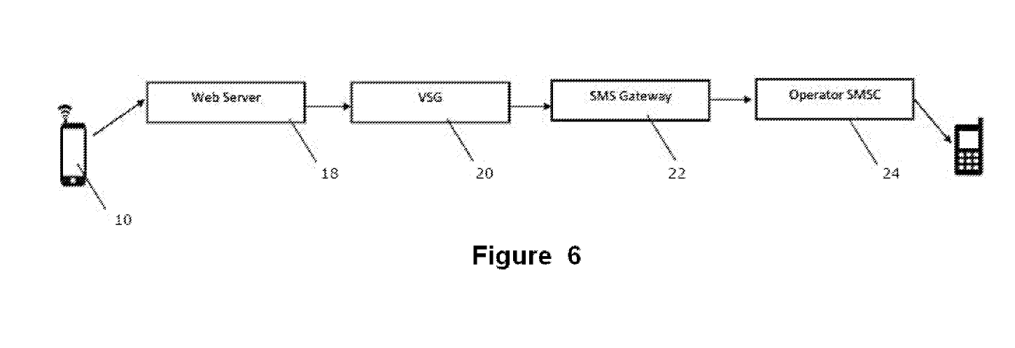

According to a second embodiment of this invention, an outgoing SMS (Short Message Service) is handled in a similiar manner but follows a signalling route through an SMS centre of the operator. FIG. 6 shows a signal flow illustrating how an outgoing SMS is sent from an internet-enabled device (10) to an arbitary telephone number. A telephone number, such as a phone number according to the E.164 standard, is assigned to a virtual phone application installed on the internet-enabled device (10) and/or a user's account of the virtual phone application. A user sends out the SMS from the internet-enabled device (10) to his chosen telephone/mobile number. The SMS is received by a Web Server (18) under the HTTP protocol and the Web Server (18) may acknowledge the receipt of SMS to the internet-enabled device. The Web Server (18) will work with a database containing a range of E.164 numbers to determine whether or not the dialed number is within the range. If it is, the SMS will be treated as IM and processed internally within the home network of the Web Server (18). If it is not, the SMS will be sent to a SMS center. The Web Server (18) sends this SMS to a VSG (20) under the TCP protocol, which may in response send back an acknowledgment. The VSG (20) receives the IM (instant message)s from the VoIP clients, such as the virtual phone application on the internet-enabled device (10), under the HTTP protocol and converts them to an HTTP format and vice versa. The VSG (20) also handles the message delivery signals and ensures the information flow status is maintained across both sides of the messaging (i.e. VOIP client side and Telco side). VSG (20) sends this SMS to a SMS Gateway (22) under the HTTP protocol, which may in response send acknowledgment back to the VSG. The SMS Gateway (22) is a network element in Telco side, which interfaces all Short Message Service Centers (SMS center or SMSC) towards external users/applications and also does the routing to appropriate destinations based on the caller and called party numbers, content of message etc. The SMS Gateway (22) sends this SMS to an operator SMSC (24) over Short Message Peer-to-Peer (SMPP) which may in response send an acknowledgment. The SMSC is a 3GPP/3GPP2 network element which manages the messaging in mobile networks. It interfaces with Mobile Switching Center (MSC) and Home Location Register (HLR) of a typical Mobile network. Operator SMSC sends this SMS to the recipient's device and then updates the delivery status accordingly.

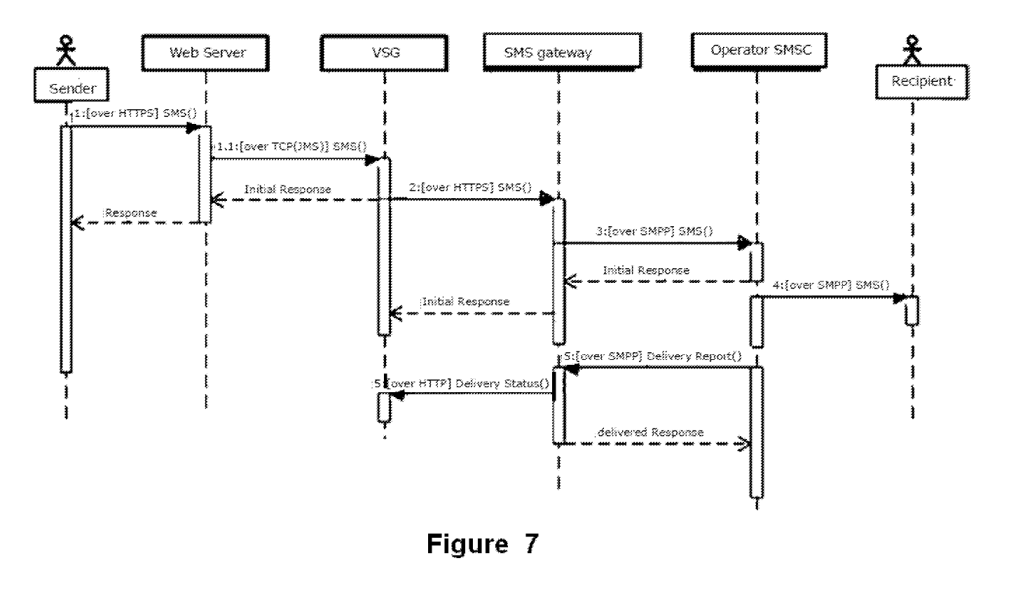

A detail of flow diagram for processing an outgoing SMS from an internet-enabled device to a regular telephony device is shown in FIG. 7. The flows are as follow: 1. user sends a SMS and received in Web Server (18) over HTTP; 1.1. Web server sends SMS to VSG (20) over TCP; 2. VSG (20) sends SMS to SMS Gateway (22) over HTTP; 3. SMS Gateway (22) sends SMS to operator SMSC (24) over SMPP; 4. Operator SMSC sends SMS to recipient; 5.updating delivery status: Operator SMCC (24) sends delivery report to SMS gateway (22) and SMS gateway (22) sends deliver status to VSG (20).

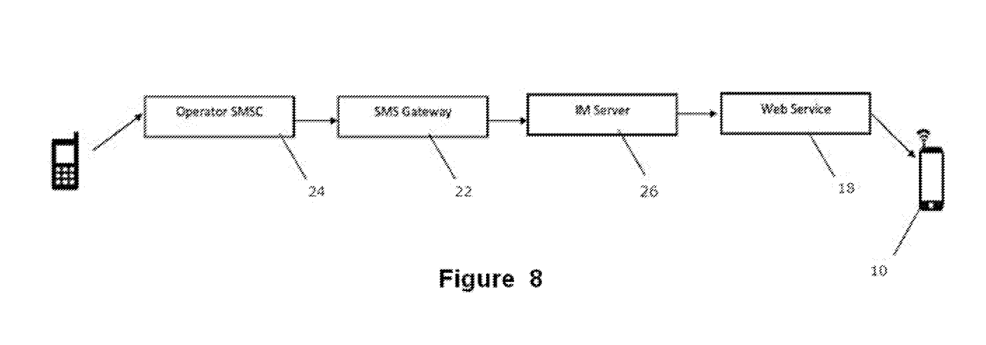

Receipt of an incoming SMS from an arbitary telephone number will be explained below by referring to FIG. 8. A SMS sent from a sender's telephone number is submitted at the SMSC network of the operator operating the sender's number. The operator SMSC (24) sends the SMS to the SMS Gateway (22) over SMPP which may in response send back an acknowledgment. The SMS Gateway (22) sends this SMS to an IM server (26) under the HTTP protocol, and may in response get an acknowledgment from the IM server. The IM server (26) sends this SMS to a virtual phone application of the recipient's device and may in response receive an acknowledgment. The recipient's device is an internet-enabled device and a VoIP user. A phone number, such as a telephone number according to the E.164 standard, is assigned to the virtual phone application of the internet enabled device. The IM server (26) sends the SMS to the virtual phone application of the internet enabled device using the E.164 number. In addition, the IM server (26) sends this SMS and reference data to a middleware for record along with a delivery status. The delivery status is then updated accordingly to sender through Operator SMSC (24).

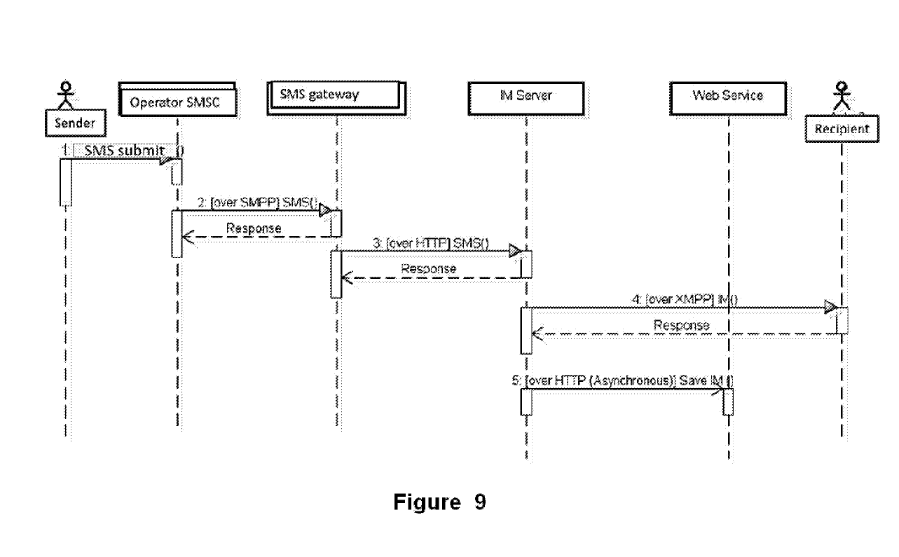

A detail of flow diagram for processing an incoming SMS from a regular telephony device to an internet-enabled device is shown in FIG. 9. The flows are as follow: 1. SMS from any number is submitted to operator SMSC (24) network; 2. Operator SMSC (24) sends SMS to SMS Gateway (22) over SMPP; 3. SMS Gateway (22) sends SMS to IM Server (26) over HTTP; 4. IM Server (22) sends SMS to VoIP user; 5. IM Server (22) sends SMS and reference data to Middleware for a record with delivery status. And the delivery status is then updated to sender through operator SMSC.

GPS Coordinates based Location resolution will be described below. The virtual phone application on the device will store the latest received GPS coordinates of the user. On trigger of any of a plurality of pre-defined events, the application will acquire up-to-date coordinates from the GPS system and utilize the previously stored coordinates to find out the distance between the last and the current coordinates. If the distance is found to be more than a pre-defined threshold value, such as five kilometers, the application will request city resolution from a MVoIP location service. Upon resolution of the current location, the virtual phone application will replace old location information with the newly resolved location information. For GPS based location resolution on the server side, the MVoIP will use local city information database, which has city geo-fence information. For each request (GPS based) from the clients, the service will apply an algorithm on geo-fences dataset to find out if the coordinates, provided by cell-phone applications, lies within any geo-fence. If it is found to be within a certain city dataset, then city information related to that geo-fence will be returned to the cell-phone application.

The following describes an algorithm (polygon method) for locating a city based on given GPS coordinates. Cities are defined as polygons. A “Ray Casting Algorithm” is used to derive the city location from the given GPS Coordinates. The Ray-Casting Algorithm is a part of Spatial Extension in Mysql 5.6.1., which uses precise object shapes. Mysql is a widely used open-source relational database management system. These versions are named with an ST_prefix. For example, Contains( ) uses object bounding rectangles, whereas ST_Contains( ) uses object shapes.
http://dev.mvsql.com/doc/refman/5.6/en/functions-for-testing-spatial-relations-between-aeometric-objects.html#function st-contains
st_* functions are used to find polygon locations from the given data. So the functionality and results provided by GISWITHIN( ) Function is available in st_within( ) with more accuracy and faster response time. MySQL table names used in the VOIP application server
   1. idn_adm_government polygon
   This table has all the city polygon records (Govt geological survey information taken as reference).
   2. City
   This table contains all the Cities which are allowed for calling from MVoIP Apps. This table identifies if the user allocated numbers are allowed to call or not in the respective city or not.
st_within and Geomfromtext functions are used for efficient point search and query Building with Latititude and Longitude within Polygons

### EXAMPLE

```
    lat=−7.211544
    long=106.845172
    SELECT polygon_id, regency_city_id,
    regency_city_name, area_code
    FROM idn_governrnent_adm_polygon WHERE
    polygon_id IN (
        SELECT polygon_id FROM idn_government_adm_polygon
        WHERE
        rect_corner1_lng < 106.845172 AND rect_corner1_lat <
−7.211544 AND
        rect_corner2_lng > 106.845172 AND rect_corner2_lat >
−7.211544 )
AND st_within(GEOMFROMTEXT(‘POINT(106.845172
−7.211544)′),geo_shape_polygon) = 1;
```

Deriving location/city based on CELL ID information from device client will be described. Any wireless operator cell ID with specific network broadcast information such as MCC, MNC, BCC, LAC is unique. This principle is used to uniquely identify the location information of users. Google MAP APIs are used as a reference to derive city from a CELL ID value. The chances of errors in case from Google API are handled as below.

The user clients which give both GPS and Cell ID information are considered as no error input. City/Location information from GPS inputs are considered as more authentic and are cached into an internal reference database which maintains cell ID to city mapping. If there is a conflict found in already mapped data then the latest information overrides. It has been observed that there are a significant number of smart mobile devices which give both cell ID and GPS information. This potential information is used to make the CELLID-CITY mapping database as self-learning and accurate.

In addition, the phone number assigned to the virtual phone of the internet enabled device (10) may have a dynamic change of number according to the location of the device, such as the city where the device is located. The VoIP server (12) may change the phone number of the virtual phone application user based on an identified location of the user using the method explained above. These numbers appear as Caller line identification (CLI) in outgoing calls and SMSs. A user maintains a permanent number that is for use in his home location, such as his home city. Whenever the user moves out of his home location and roams into a visited location, a randomly selected temporary number is allocated for outgoing and incoming calls as well as SMSs. While the user is outside his home location, incoming calls and SMSs can be received in both numbers (home location number and the temporary number).

Further, the virtual phone of the internet enabled device (10) is capable of making an emergency number dialling. A database of locations and numbers for emergency services such as fire, police and ambulance service are maintained in the VoIP server (12). When customer dials emergency shortcodes, necessary translation to long digit numbers are performed by the Mobile VoIP server (12) and the translated long digit numbers are transfered to the GMSC (16) for necessary routing.

In addition, the virtual phone application installed in the enabled internet device (10) can provide identification of user location using inputs which are taken from at least one of the following four sources: Cell ID information from device, IP address of the user client, GPS reading from the device, trusted SSID of WIFI Access point. Following algorithms use input from at least one of the above four sources to derive the location information. The device (Mobile Platform) client fetches the updated information (cell-info or GPS coordinates) as soon as the user starts using the virtual phone application. The client will also check current location information with the last location information (cached earlier) and will determine if there is a location change. The above steps ensure that before making any calls or sending any messages via the Mobile VoIP system (12), the virtual phone application and system have the most up-to-date location information of the user. For Cell-site ID and Wi-Fi Hotspot based locations, the virtual phone application will consider change of Cell-site or Wi-Fi Hotspot as a “substantial change” and will request MVoIP server to resolve current location.

The exemplary embodiments, including the virtual phone application, also encompass a non-transitory computer-readable medium that contains software program instructions, where execution of the software program instructions by at least one data processor results in performance of operations that comprise execution of the methods according to the embodiments of the present invention.

The various embodiments of the present invention described above may be viewed as method steps, and/or as operations that result from operation of computer program code, and/or as a plurality of coupled logic circuit elements constructed to carry out the associated function(s).

The exemplary embodiments also pertain to one or more apparatuses each comprising a processor and a memory including computer program code. The memory and computer program code are configured to, with the processor, cause the apparatus at least to perform one or more of the methods described above and/or as defined in the claims.

For example, the internet enabled device (10) may comprise at least one processor and at least one memory including computer program code, the memory and computer program code being configured to, with the processor, cause the internet enabled device (10) at least to implement a virtual phone application, wherein the virtual phone application is assigned with a telephone number according to the E.164 standard, with which the virtual phone application can initiate or receive a telephone call or a SMS via VoIP.

In general, the various modules, such as the internet-enabled device, VoIP server, SBC, GMSC, web server, VSG, SMS gateway, operator SMSC and CRBT platform, according to the exemplary embodiments maybe implemented in hardware or special purpose circuits, software, logic, chip sets, e.g., a WLAN chip set or chip sets, or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the 3^{rd} generation mobile phone system, it should be appreciated that the exemplary embodiments of this invention are not limited for use with only this one particular type of wireless communication system, and that they may be used to advantage in other wireless communication systems.

In the exemplary embodiments, a telephone number according to the E.164 standard is assigned to at least one of the following: the internet-enabled device, the virtual phone application installed on the internet-enabled device, a user's account of the virtual phone application and a user using the phone. Outgoing calls and SMSs can be transmitted from this E.164 number, and incoming calls and SMSs are routed to and received at this number.

It should be noted that the terms “connected,” “coupled,” “transmit to”, “send to” or any variant thereof, mean any connection, coupling, transmitting, sending, either direct or indirect, between two or more elements, and may encompass the presence of one or more intermediate elements between two elements. The transmission and sending may involve the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

### REFERENCE NUMBER ON THE FIGURES

10 an internet enabled device
12 VoIP server
14 Session Border Controller (SBC)
15 Cloud servers
16 Gateway switching centre (GMSC)
17 Ring Back Tongs (CRBT) platform
18 Web Server
20 Vector Signal Generator (VSG)
22 SMS Gateway
24 Operator SMSC
26 IM server

1. An internet enabled device comprising:
a processor configured to implement a virtual phone application;
wherein the virtual phone application is assigned with a telephone number according to the E.164 standard, and the virtual phone application can initiate or receive a telephone call or a SMS via VoIP with the telephone number.

2. An apparatus comprising:
a processor configured to receive a call request or a SMS directed to a E.164 number assigned to a virtual phone application installed on a internet-enabled device;
wherein the apparatus is configured to analyze the E.164 number, and if the E.164 number is within a range of E.164 numbers associated with VoIP service clients of a VoIP server, to forward the call request to the VoIP server, or if the E.164 number is within a range of E.164 numbers associated with clients of an IM server, to forward the SMS to the IM server.

3. A server comprising:
a processor configured to provide VoIP services to a plurality of internet-enabled devices;
wherein each of said plurality of internet-enabled devices has a virtual phone application assigned with its respective E.164 number; and
wherein the server is configured to analysis a dialed number associated with an incoming call or an incoming SMS, and if the dialed number matches one of the E.164 numbers associated with one of the plurality of the internet-enabled devices, to forward the incoming call or the incoming SMS to said one of the plurality of internet enabled devices.

4. A communication system for establishing a phone call via a virtual phone application using a VoIP network, the communication system comprising:
an internet enabled telephone device configured to run a virtual phone application which is able to make a call request via VoIP from a telephone number under the E.164 standard;
a VoIP server configured to receive the call request from the internet enabled telephone device and to analyze the dialed number of the call request;
a session border controller (SBC) configured to receive the call request with the E.164 number from the VoIP server; and
a gateway mobile switching center (GMSC) configured to receive and analyze the call request with the E.164 number from the SBC and route the call request to a respective point of interconnection.

5. The communication system of claim 4, wherein the VoIP server is further configured to authenticate the calling party.

6. The communication system of claim 4, wherein the VoIP server is further configured to charge the call.

7. The communication system of claim 4, wherein the SBC is further configured to signal parameter changes to handle the compatibilities.

8. The communication system of claim 4, wherein the GMSC is further configured to query a home location register if the call has to be terminated in the GMSC's home wireless network.

9. A communication system for receiving a phone call via a virtual phone application using a VoIP network, the communication system comprising:
a gateway mobile switching center (GMSC) configured to receive and analyze an incoming call request with a dialed telephone number according to the E.164 standard;
a session border controller (SBC) configured to receive the incoming call request with the E.164 number from the GMSC;
a VoIP server configured to receive the incoming call request from the SBC; and
an internet enabled telephone device configured to run a virtual phone application which is able to receive from the VoIP server and process, a call request with the dialed telephone number according to the E.164 standard via VoIP.

10. The communication system of claim 9, wherein, when receiving the incoming call, the SBC is further configured to receive the incoming call from the GMSC and do SIP signaling modifications which include managing and translating a status of the incoming call.

11. The communication system of claim 9, wherein, when receiving the incoming call, the VOIP server is further configured to receive the dialed number of the incoming call and analyze a current status of a user of the dialled number, and if the user is on line, to place the incoming call directly to a user client, if the user is not active or on line, to send a paging notification through Cloud servers from Google, Apple or Blackberry to notify the client, wherein the client notify process is followed by location notification to the server and the incoming call is delivered based on location of user client.

12. A communication system for establishing a short message service (SMS) via a virtual phone application using a VoIP network, the communication system comprising:
an internet enabled device configured to run a virtual phone application for initiating a SMS request from a telephone number under the E.164 standard via VoIP;
a web server configured to receive the SMS request from the internet enabled device with the telephone number under the E.164 standard;
a Vector Signal Generator (VSG) configured to receive the SMS with the telephone number under the E.164 standard over TCP from the web server;
a SMS gateway configured to receive the SMS with the telephone number under the E.164 standard over HTTP from the VSG; and
an operator of Short Message Service Center (SMSC) network configured to receive the SMS with the telephone number under the E.164 standard and send the SMS to the recipient.

13. A communication system for establishing a short message service (SMS) via a virtual phone application using a VoIP network, the communication system comprising:
an operator of Short Message Service Center (SMSC) network configured to receive, from a sender, an incoming SMS to be sent to a telephone number according to the E.164 standard;
a SMS gateway configured to receive the SMS over HTTP from a Vector Signal Generator (VSG);
a IM server configured to receive the SMS from the SMS gateway; and
an internet enabled device configured to run an virtual phone application assigned with the telephone number according to the E.164 standard, wherein the virtual phone application is for receiving the SMS request from the IM server via VoIP.

14. The communication system of claim 13, wherein, when receiving the incoming SMS, the SMS gateway is further configured to receive the SMS over SMPP from the operator of SMSC network.

15. The communication system of claim 13, wherein, when receiving the incoming SMS, the IM server is further configured to receive the SMS from the SMS gateway over HTTP.

16. The communication system of claim 13, wherein, when receiving an incoming SMS, the IM server is further configured to send the SMS and reference data to a Middleware for record along with a delivery status which is then updated accordingly to sender through Operator of SMSC network.

17. The communication system of claim 13, wherein, the phone number assigned to the virtual phone application installed on the internet enabled device has dynamic change of numbering based on city location.

18. The communication system of claim 13, wherein, the virtual phone application of the internet enabled device is capable of making an emergency number dialing; and the database of locations and numbers for emergency services such as fire, Police and ambulance service are maintained in VOIP server.

19. The communication system of claim 13, wherein the virtual phone application of the internet enabled device is coupled to a Color Ring Back Tone platform which provides the caller with a ring back tone during ringing as a music of the choice of the called party.

20. The communication system of claim 13, wherein the virtual phone of the internet enabled device is capable of providing a ring tone differentiation with respect to the status of the call by the mobile VoIP server (12).

21. The communication system of claim 20, wherein the status of the call includes at least one of the following: when the call reaches the VoIP Server;
the called party is paged/notified through Google Cloud Messaging (GCM), Apple Push Notification (APN); the application is opened with answer/reject screen; call is rejected; call is not answered and the called party is not reachable.

22. A method of executing a virtual phone application program run on an internet enabled device, the method comprising:
initiating or receiving a telephone call or a SMS via VoIP;
wherein the virtual phone application is assigned with a telephone number according to the E.164 standard.
